(19) United States
(12) Patent Application Publication
(10) Pub. No.: US 2019/0282026 A1
(43) Pub. Date: Sep. 19, 2019

(54) TEA MACHINE DRIPPING AND BREWING TEA WITH COLD WATER

(71) Applicant: Liyang Chunyu Agricultural Technology Co., Ltd., Liyang (CN)

(72) Inventors: Shiyuan HUANG, Liyang (CN); Wenlong HUANG, Liyang (CN); Mingguang WU, Liyang (CN)

(21) Appl. No.: 16/104,886

(22) Filed: Aug. 18, 2018

(30) Foreign Application Priority Data
Mar. 13, 2018 (CN) 201810204215.3

(51) Int. Cl. A47J 31/44; A47J 31/10; A23F 3/18

(52) U.S. Cl. CPC A47J 31/4403; A23F 3/18; A47J 31/10

(57) ABSTRACT

The present disclosure provides a tea machine dripping and brewing tea with cold water, including a water storage tank, dripping pipe, tea cake rack, cup holder and a main control unit. One end of the dripping pipe is connected with the bottom of the water storage tank, and the other end is an open end. A drip controller is installed on the dripping pipe. The cup holder is located right below the tea cake rack for placing a metering cup, and is provided with a water cup detecting apparatus and a water quantity detecting apparatus. The main control unit is connected with the drip controller, the water cup detecting apparatus and the water quantity detecting apparatus, and commands opening and closing of the drip controller, so as to brew tea with cold water to dissolve out effective ingredients of the tea.

### CROSS-REFERENCE TO RELATED APPLICATIONS

This application claims priority to Chinese application no. 201810204215.3 with a filing date of Mar. 13, 2018. The content of the aforementioned application, including any intervening amendments thereto, are incorporated herein by reference.

### TECHNICAL FIELD

The present disclosure relates to an automatic tea brewing and drinking machine.

### BACKGROUND

Drinking of tea brewed with cool water not more than 20° C. or with cold water of about 4° C. is a new way of drinking tea. Drinking of this kind of tea brewed with cool water or cold water is cool to quench thirst and further very convenient, which is especially suitable for drinking in summer, favored by the new generation. The traditional tea processing technology pays attention to standard tea quality of color, fragrance, taste shape and leaf folder. The shape and the leaf folder refer to the shape and the appearance of tea leaves. Therefore, the traditional tea processing technology requires to keep the tea leaves in a good shape, so that the tea cells after treatment are still complete. The effective substances of the tea is dissolved in water by leaching when water is immersed into spongy micropores of the processed tea during brewing. There is no problem in the dissolution of the effective ingredients when the tea processed by this traditional tea processing technology is brewed with hot water. But when the tea is brewed with cool water or cold water, the dissolution rate of the effective ingredients of the tea is low. This is because the effective ingredients of the tea are wrapped in tea cells, the water molecules are underpowered at low temperature, and the effective ingredients are difficult to dissolve out through the tea micropores when the tea cells are complete.

### SUMMARY

The present disclosure aims to solve the problem that water modules are underpowered and are difficult to dissolve effective ingredients of the tea when the water temperature is low.

To solve the above problem, the present disclosure adopts the following solution:

A tea machine dripping and brewing tea with cold water comprises a water storage tank, dripping pipe, tea cake rack, cup holder and a main control unit, wherein one end of the dripping pipe is connected with a bottom of the water storage tank, and the other end is an open end; the dripping pipe are provided with drip controller for controlling the starting and stopping of dripping; the tea cake rack is used for placing a tea cake box; the tea cake box is used for placing tea cakes; when the tea cake box is placed on the tea cake rack, the open end of the dripping pipe is located right above the tea cakes in tea cake box, so that water in the water storage tank can drip on a center of each tea cake in the tea cake box through the dripping pipe; the cup holder is used for placing a metering cup; the cup holder is located right below the tea cake rack, so that the water that drips in the tea cake box can drip into the metering cup placed on the cup holder through the tea cake box; the cup holder is provided with a water cup detecting apparatus and a water quantity detecting apparatus; the drip controller, the water cup detecting apparatus and the water quantity detecting apparatus are connected with the main control unit; and the main control unit is used for: detecting whether the metering cup is placed on the cup holder through the water cup detecting apparatus, detecting the water quantity in the metering cup on the cup holder through the water quantity detecting apparatus, and then commanding the opening and closing of the drip controller according to whether the metering cup is placed on the cup holder and the water quantity in the metering cup on the cup holder.

Further, the dripping pipe are further provided with a water speed controller; and the water speed controller is used for controlling a dripping speed of the dripping pipe.

Further, the water cup detecting apparatus and the water quantity detecting apparatus are weight detecting apparatuses; the weight detecting apparatuses are connected with the main control unit; and the main control unit judges whether the metering cup is placed on the cup holder and the water quantity in the metering cup on the cup holder through weight values detected by the weight detecting apparatuses.

Further, a plurality of dripping pipe, tea cake rack and cup holder are arranged.

Further, a tea cake detecting apparatus is installed between the tea cake rack and the tea cake box; the tea cake detecting apparatus is connected with the main control unit; and the main control unit detects whether the tea cake box is placed on the tea cake rack through the tea cake detecting apparatus, and then commands the opening and closing of the drip controller according to whether the tea cake box is placed on the tea cake rack.

Further, the tea cake detecting apparatus comprises a permanent magnet installed on the tea cake box and a magnetic switch installed on the tea cake rack; and when the permanent magnet on the tea cake box is close to the magnetic switch, and the magnetic switch is connected to circuits on both ends.

Further, the dripping and brewing machine further comprises a cup box; and the cup holder are located in the cup box.

Further, a refrigerating apparatus and a temperature detecting apparatus are arranged in the cup box; the refrigerating apparatus and the temperature detecting apparatus are connected with the main control unit; and the main control unit detects a temperature in the cup box through the temperature detecting apparatus, and then commands to turn on and turn off the refrigerating apparatus according to the temperature in the cup box.

Further, the cup box comprises a box door; an opening and closing sensor is provided at a closing position of the cup box and the box door for sensing an opening and closing of the box door; and the opening and closing sensor is connected with the main control unit.

Further, the dripping and brewing machine further comprises a display panel; the display panel is connected with the main control unit; and the display panel is used for indicating whether or not the metering cup is placed on the cup holder, the water quantity in the metering cup on the cup holder and the temperature in the cup box.

Further, the dripping and brewing machine further comprises a water pump and an outer water pipe; the water storage tank is provided with a water level gauge; the outer water pipe is connected with the water storage tank through the water pump; the water pump and the water level gauge are connected with the main control unit; the main control unit is further used for detecting a water quantity in the water storage tank through the water level gauge; and when the water quantity in the water storage tank is lower than a preset threshold, the water pump is turned on.

The present disclosure has the following technical effects:

1. The present disclosure creates a new manner of tea drinking.

2. Through the mode of dripping, brewing and flowing, the problem that the water modules are underpowered when the water temperature is low is compensated, and the effective ingredients of the tea are dissolved out more effectively.

3. Through a refrigerating control of the refrigerating apparatus, the water temperature for dripping and brewing is controlled to be low, and oxidation of tea is relieved so that the tea water can be kept fresh for a longer time.

### BRIEF DESCRIPTION OF THE DRAWINGS

FIG. 1 is an overall structural schematic diagram of an embodiment of the present disclosure;

FIG. 2 is a front structural schematic diagram of an embodiment of the present disclosure;

FIG. 3 is a structural schematic diagram of a tea cake box of an embodiment of the present disclosure;

FIG. 4 is a structural schematic diagram of a tea cake disk of an embodiment of the present disclosure; and

FIG. 5 is a structural schematic diagram of electric connection of an embodiment of the present disclosure.

### DETAILED DESCRIPTION OF THE DESCRIPTION

The present disclosure is further described in detail in combination with the drawings.

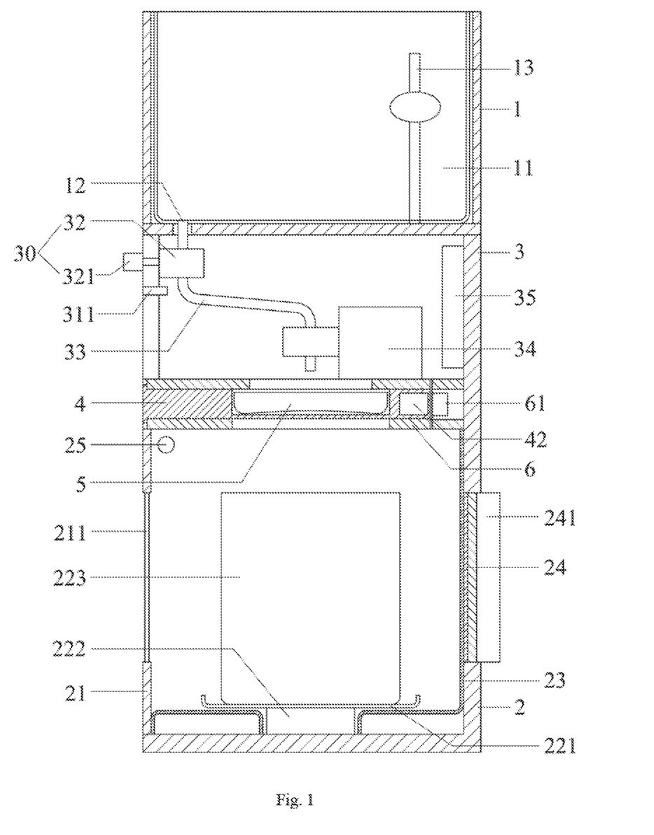

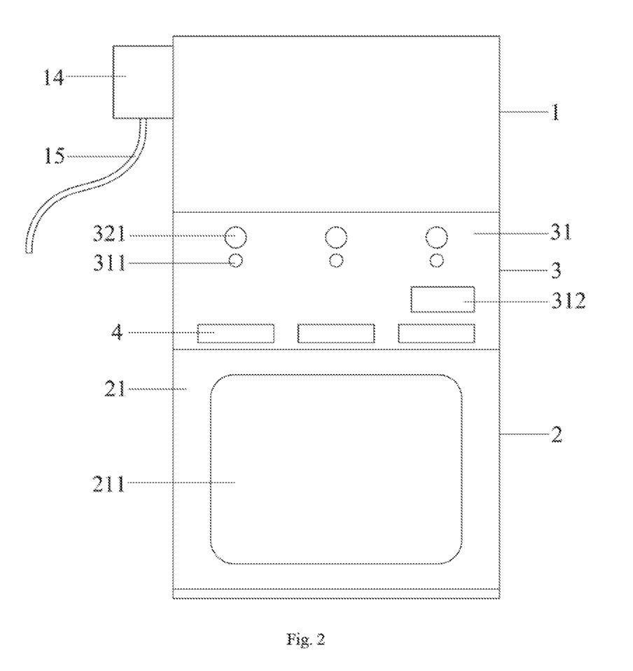

As shown in FIG. 1 and FIG. 2, the tea machine dripping and brewing tea with cold water has a box structure including three parts: a water storage tank portion 1, a control portion 3 and a cup box 2. The water storage tank portion 1, the control portion 3 and the cup box 2 are arranged in a top-middle-bottom layout. A water storage tank 11, a water pump 14 and an external water pipe 15 are installed in the water storage tank portion 1. The control portion 3 is provided with water speed control valve 32, dripping pipe 33, drip controller 34, tea cake rack 6 and a main control unit 35. The main control unit 35 includes a circuit board, and a microprocessor, a memory and a connecting circuit disposed on the circuit board. The microprocessor is used to execute preset programs.

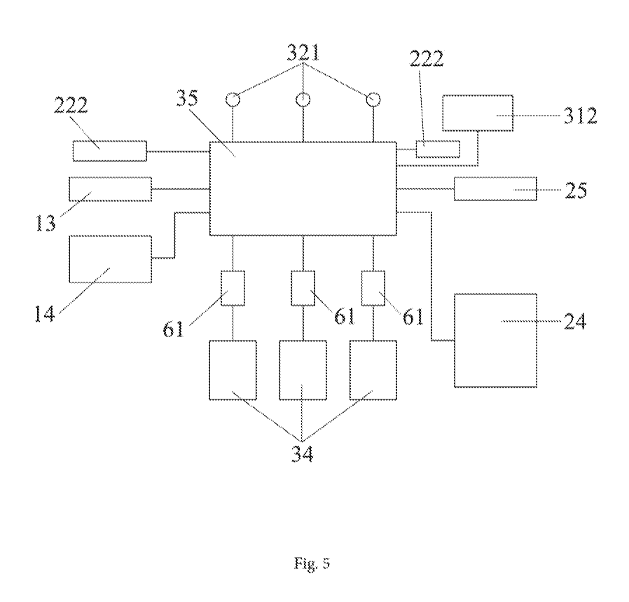

A water level gauge 13 is installed in the water storage tank 11. The external water pipe 15 is connected with the water storage tank 11 through the water pump 14. A movable end of the external water pipe 15 is placed in an external drinking bucket. As shown in FIG. 5, the water level gauge 13 and the water pump 14 are connected with the main control unit. The water level gauge 13 is used for measuring a water depth in the water storage tank 11, and the water depth is used to indicate a water quantity in the water storage tank 11. Thus, the main control unit detects the water quantity in the water storage tank 11 in real time through the water level gauge 13. When the water quantity in the water storage tank 11 is lower than a preset low water quantity threshold, the water pump 14 is turned on. Thus, drinking water in the external drinking bucket can be pumped into the water storage tank 11 through the water pump 14. When the water quantity in the water storage tank 11 is higher than a preset high water quantity threshold, the water pump 14 is turned off.

A display panel 31 is arranged in front surface of the control portion 3 and a back plate is arranged in rear of the control portion 3. The main control unit 35 is installed on the back plate. LED indicator 311, a digital display screen 312 and a water speed control knob 321 are installed on the display panel 31. The LED indicator 311 and the digital display screen 312 are connected with the main control unit. The LED indicator 311 is used for displaying a dripping state. The digital display screen 312 is used for displaying a problem in the cup box. Three LED indicator 311 are arranged.

One end of the dripping pipe 33 is connected with a bottom of the water storage tank 11, and is communicated with the water storage tank 11 through an opening 12 at the bottom of the water storage tank 11, and the other end is an open end. The dripping pipe 33 is provided with the water speed control valve 32 and the drip controller 34. The open end of the dripping pipe 33 is fixed through the drip controller 34. The drip controller 34 is fixed to a baffle plate between the control portion 3 and the cup box 2. The drip controller 34 is preferably a drip control valve. The drip controller 34 is connected to the main control unit for controlling dripping of the dripping pipe 33. The water speed control knob 321 is connected with the water speed control valve 32. In the present embodiment, the dripping pipe 33 is flexible pipe. Lateral compression mechanism is arranged in the water speed control valve 32. The lateral compression mechanism presses on the side of the dripping pipe 33. The water speed control knob 321 is connected with the lateral compression mechanism. The lateral pressure of the lateral compression mechanism for the dripping pipe 33 is controlled through the rotation of the water speed control knob 321, thereby controlling the dripping speed of the dripping pipe 33. Namely, in the present embodiment, the water speed control knob 321 and the water speed control valve 32 form a water speed controller 30 described in the present disclosure. Three dripping pipes 33 are arranged. Correspondingly, three water speed controllers 30 and three drip controllers are arranged.

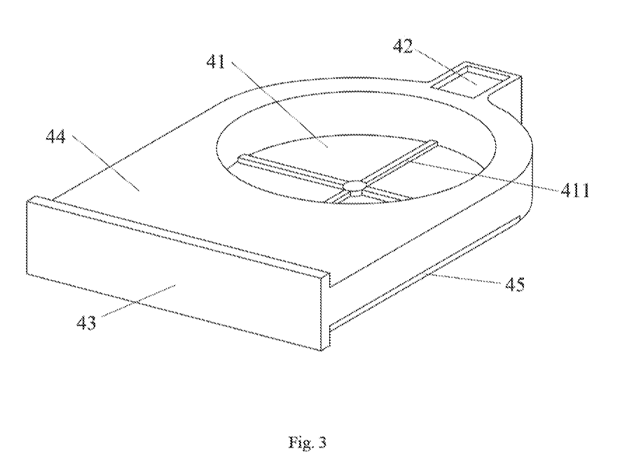

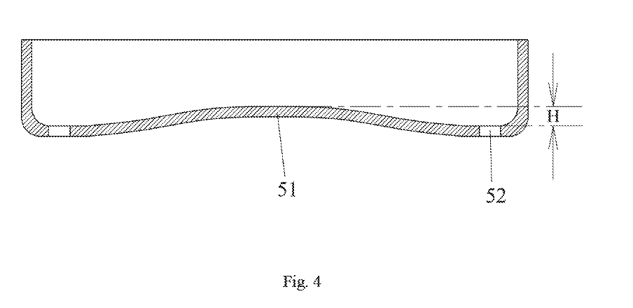

The tea cake rack 6 is used for placing the tea cake box 4 and is arranged on the baffle plate between the control portion 3 and the cup box 2. Three tea cake racks 6 and three tea cake boxes 4 are respectively arranged. The tea cake box 4 is used for placing tea cakes. The tea cake box 4 has a drawer structure, as shown in FIG. 3, and includes a front baffle plate 43 and a box body 44. A circular through hole 41 is formed in the box body 44. A tea disk rack 411 is arranged at a bottom of the circular through hole 41. Clamping grooves 45 are formed on both sides of the box body 44, such that the tea cake box 4 can be clamped to the tea cake rack 6. The tea cake box 4 and the tea cake rack 6 are separable. The circular through hole 41 of each of the tea cake boxes 4 is used for placing a tea cake disk 5. The tea cake disk 5 is used for placing the tea cakes. The tea cake disk 5 in the circular through hole 41 is supported through the tea disk rack 411. The tea cake disk 5 and the tea cake box 4 are separable. The tea cake disk 5 is in a shape of a disc, as shown in FIG. 4. The middle of the bottom surface of the tea cake disk 5 is convex upwards to form a bulge portion 51, and the edge is concave downward. A plurality of water outlets 52 are formed in a bottom surface of the tea cake disk 5. The water outlets 52 are located in a concave portion of the edge of the bottom surface of the tea cake disk 5. The tea cake box 4 is inserted into the tea cake rack 6 through a drawing-inserting manner, and can further be taken out from the tea cake rack 6 through the drawing-inserting manner. When the tea cake box 4 is placed on the tea cake rack 6, an open end of the dripping pipe 33 is located in the center of the tea cake disk 5. Thus, when the water in the dripping pipe 33 drips into the tea cake disk 5 from the center, the water flows towards the edge, so that the water wets the tea cakes placed in the tea cake disk 5 and then drips down through the water outlets at the edge after wetting the tea cakes.

A convex portion is arranged at a front end of the tea cake box 4. A permanent magnet 42 is installed in the convex portion. A magnetic switch 61 is arranged at an inner side of the tea cake rack 6. The drip controller 34 is connected with the main control unit through the magnetic switch 61. When the tea cake box 4 is inserted into the tea cake rack 6 through the drawing-inserting manner, the permanent magnet 42 at the front end of the tea cake box 4 is located close to the magnetic switch 61, and the magnetic switch 61 is connected to the circuits on both ends under the magnetic action of the permanent magnet 42. Specifically, the drip controller 34 and the main control unit are communicated. Namely, the drip controller 34 is in a normally closed state; and only when the tea cake box 4 is inserted into the tea cake rack 6, the main control unit can be connected to the drip controller 34.

The cup box 2 is a sealed tank body structure. An openable tank body door 21 is arranged in front of the cup box 2, and a back plate is arranged at the rear of the cup box 2. The tank body door 21 is provided with a transparent window 211. A thermometer 25 is arranged in a tank body of the cup box 2. The thermometer 25 is the temperature detecting apparatus described in the present disclosure, and is connected with the main control unit. The refrigerating apparatus is installed on the back plate. The refrigerating apparatus is composed of a semiconductor refrigeration sheet 24 and a radiator 241. Namely, the refrigerating apparatus in the present embodiment is a semiconductor refrigerating apparatus. Specifically, the tank body of the cup box 2 is composed of an outer shell and an inner shell 23. The inner shell 23 is made of an aluminum embossed sheet. The refrigerating apparatus is installed on the outer shell of the tank body of the cup box 2. The semiconductor refrigeration sheet 24 is close to the inner shell 23. The radiator 241 is close to the semiconductor refrigeration sheet 24. The semiconductor refrigeration sheet 24 is connected with the main control unit. The main control unit detects the temperature in the cup box 2 through the thermometer 25. When the temperature in the cup box 2 is higher than a preset high temperature threshold, the semiconductor refrigeration sheet 24 is started to refrigerate the cup box 2. When the temperature in the cup box 2 is lower than a preset low temperature threshold, the refrigeration of the semiconductor refrigeration sheet 24 is stopped, so that the temperature in the cup box 2 keeps a low temperature state. In the present embodiment, the high temperature threshold is 6° C. and the low temperature threshold is 2° C. Namely, the temperature in the cup box 2 is controlled between 2° C. and 6° C.

Three cup holders are arranged at the bottom of the cup box 2. The cup holder is used for placing the metering cup 223. The cup holder comprises a water cup disk 221 and a weight detecting apparatus 222. The weight detecting apparatus 222 is preferably a poidometer in the present embodiment, and is used for detecting the metering cup 223 on the water cup disk 221 and the weight of the water in the metering cup 223. The weight detecting apparatus 222 is connected with the main control unit. The main control unit detects whether the metering cup is placed on the cup holder and the water quantity in the metering cup on the cup holder through weight values detected by the weight detecting apparatus 222, and then commands the opening and closing of the drip controller according to whether the metering cup is placed on the cup holder and the water quantity in the metering cup on the cup holder.

In a preferred embodiment, an opening and closing sensor 26 is provided at a closing position of the cup box 2 and the box door 21 for sensing an opening and closing of the box door 21, and the opening and closing sensor 26 may specifically be a pressure sensor, an infrared sensing sensor, or a photosensitive sensor, the opening and closing sensor 26 is connected with the main control unit 35, and the opening and closing sensor 26 senses the opening and closing of the box door 21 to control the opening and closing of the drip controller 34.

In the present embodiment, three cup holders, three tea cake boxes 4, three tea cake racks 6, three LED indicators 311, three water speed controllers 30, three drip controllers 34 and three dripping pipes 33 are arranged to form three sets of tea dripping and brewing machine. Those skilled in the art can understand that one, two, and even seven or eight sets of dripping and brewing machines for tea can be formed.

The working principle of the present embodiment is as follows:

When the tea cake box 4 is taken out from the tea cake rack 6, the drip controller 34 is turned off. Meanwhile, the main control unit judges that no tea cake exists in the tea cake box 4 through the magnetic switch 61, and the corresponding LED indicating lamp 311 is turned off.

When the tea cake box 4 is inserted into the tea cake rack 6, the main control unit judges that a tea cake is placed in the current tea cake box 4 through the magnetic switch 61, time is started to keep and the corresponding LED indicating lamp 311 is turned on. If the main control unit fails to detect that the metering cup is placed on the cup holder through the weight detecting apparatus 222 at this moment, then the drip controller is turned off. At this moment, the corresponding LED indicating lamp 311 is shown in yellow. If the main control unit fails to detect that the metering cup is placed on the cup holder through the weight detecting apparatus 222 at this moment and the main control unit detects that the water quantity in the metering cup is not full through the weight detecting apparatus 222, then the drip controller is turned on to start to dripping. At this moment, the corresponding LED indicating lamp 311 is shown in yellow. When the main control unit detects that the water in the corresponding metering cup is full through the weight detecting apparatus 222, the drip controller is turned off and the corresponding LED indicating lamp 311 is shown in green.

If the tea cake box 4 has been inserted into the tea cake rack 6 for over 18 hours, the main control unit judges that the tea cake of the tea cake box 4 is used for too long. At this moment, the drip controller is turned off and the corresponding LED indicating lamp is shown in red, to prompt to replace the tea cake.

When the opening and closing sensor 26 senses the opening of the box door 21, the drip controller 34 immediately stops dripping. When the box door 21 is closed, the drip controller continues to control the opening and closing of the dripping pipe 33 according to the working principle of the above embodiment.

Equivalently, the magnetic control switch 61, the weight detecting apparatus 222 and the opening and closing sensor 26 are connected in series to control the opening and closing of the drip controller 34. As long as one of the magnetic control switch 61, the weight detecting apparatus 222 and the opening and closing sensor 26 is not satisfied with the opening condition of the drip controller 34, the drip controller 34 stops dripping, and when the magnetic control switch 61, the weight detecting apparatus 222 and the opening and closing sensor 26 all satisfy the opening condition of the drip controller 34, the drip controller 34 starts dripping.

In addition, it should be noted that:

1. In the present embodiment, the detection of the weight detecting apparatus 222 is used to judge whether the metering cup is placed on the cup holder and whether the water quantity in the metering cup is full. Those skilled in the art can understand that whether the metering cup is placed on the cup holder and whether the water quantity in the metering cup is full can be detected separately. For example, whether the metering cup is placed on the cup holder can be realized through a pressure sensor; and whether the water quantity in the metering cup is full can be judged through laser reflection of the water in the metering cup, or whether the water quantity in the metering cup is full can be judged through a refractive index on a specific height of the transparent metering cup. Namely, functions achieved by the weight detecting apparatus in the present embodiment can be achieved respectively through the water cup detecting apparatus and the water quantity detecting apparatus. Thus, the main control unit detects whether the metering cup is placed on the cup holder through the water cup detecting apparatus and detects whether the water quantity in the metering cup on the cup holder is full through the water quantity detecting apparatus.

2. In the present embodiment, the permanent magnet on the tea cake box 4 and the magnetic switch 61 on the tea cake rack 6 form the tea cake detecting apparatus. The tea cake detecting apparatus is connected with the main control unit. Thus, the main control unit detects whether the tea cake box is placed on the tea cake rack through the tea cake detecting apparatus, and then commands the opening and closing of the drip controller according to whether the tea cake box is placed on the tea cake rack. Those skilled in the art can understand that the tea cake detecting apparatus can further adopt other manners, such as a proximity sensor or a laser penetration sensor. The laser penetration sensor judges whether the tea cake box is placed on the tea cake rack by detecting the transparency of the tea cake disk 5.

3. The present embodiment comprises the water pump 14 and the external water pipe 15. Those skilled in the art can understand that, if the capacity of the water storage tank 11 is large enough, it is not necessary to connect the external drinking bucket through the water pump 14 and the external water pipe 15.

4. The water storage tank 11 can further adopt an external manner, such as the external drinking bucket. In this manner, the dripping control valve as the drip controller 34 in the present embodiment can be directly replaced with the water pump.

A comparison table of precipitation of effective ingredients of tea between dripping and brewing of tea cakes and soaking with hot water is shown below.

| | Inclusions | Amino Acid | Caffeine | Tea Polyphenol |
|---|---|---|---|---|
| | (mg/ml) | (mg/ml) | (mg/ml) | (mg/ml) |
| Dripping and | 1.93 | 0.38 | 0.123 | 0.29 |
| brewing | | | | |
| Soaking | 1.78 | 0.36 | 0.083 | 0.27 |

The upper column shows the contents of all substances in the tea water after 5 g of tea cakes are brewed in cold water with a temperature of 18° C. and a mass of 200 g at low speed for 1 hour, and the lower column shows the contents of all substances in the tea water after 5 g of tea cakes prepared by a traditional tea making technology are brewed in hot water with a temperature of 70° C. and a mass of 200 g for 20 minutes. It can be seen that the effective ingredients of the tea can further be dissolved in the tea water through the dripping and brewing manner, and the dissolving quantity is not less than that of the traditional technology of brewing with hot water.

What is claimed is:

1. A tea machine dripping and brewing tea with cold water, comprising a water storage tank, a dripping pipe, a tea cake rack, a cup holder and a main control unit; wherein one end of the dripping pipe is connected with the bottom of the water storage tank and the other end is an open end; the dripping pipe is provided with a drip controller for controlling an opening and closing of dripping; the tea cake rack is used for placing a tea cake box; the tea cake box is used for placing tea cakes; the open end of the dripping pipe is located right above the tea cakes in the tea cake box such that water in the water storage tank drips on a center of each of the tea cakes in the tea cake box through the dripping pipe; the cup holder is used for placing a metering cup; the cup holder is provided right below the tea cake rack, and the water dripping in the tea cake box drips into the metering cup through the tea cake box; the cup holder is provided with a water cup detecting apparatus and a water quantity detecting apparatus; the drip controller, the water cup detecting apparatus and the water quantity detecting apparatus are connected with the main control unit; and the main control unit is used for detecting through the water cup detecting apparatus whether the metering cup is placed on the cup holder, detecting water quantity in the metering cup on the cup holder through the water quantity detecting apparatus, and controlling an opening or closing of the drip controller according to whether or not the metering cup is placed on the cup holder and according to the water quantity in the metering cup on the cup holder.

2. The tea machine dripping and brewing tea with cold water of claim 1, wherein the dripping pipe is further provided with a water speed controller; and the water speed controller is used for controlling a dripping speed of the dripping pipe.

3. The tea machine dripping and brewing tea with cold water of claim 1, wherein the water cup detecting apparatus and the water quantity detecting apparatus are weight detecting apparatuses; the weight detecting apparatuses are connected with the main control unit; and the main control unit judges whether or not the metering cup is placed on the cup holder and the water quantity in the metering cup on the cup holder through weight values detected by the weight detecting apparatuses.

4. The tea machine dripping and brewing tea with cold water of claim 1, wherein a plurality of dripping pipes, tea cake racks and cup holders are arranged.

5. The tea machine dripping and brewing tea with cold water of claim 1, wherein a tea cake detecting apparatus is provided between the tea cake rack and the tea cake box; the tea cake detecting apparatus is connected with the main control unit; the main control unit detects whether or not the tea cake box is placed on the tea cake rack through the tea cake detecting apparatus, and controls the opening or closing of the drip controller according to whether or not the tea cake box is placed on the tea cake rack.

6. The tea machine dripping and brewing tea with cold water of claim 5, wherein the tea cake detecting apparatus comprises a permanent magnet installed on the tea cake box and a magnetic switch installed on the tea cake rack; and when the permanent magnet on the tea cake box is close to the magnetic switch, the magnetic switch is connected to circuits on both ends.

7. The tea machine dripping and brewing tea with cold water of claim 1, wherein the dripping and brewing machine further comprises a cup box; and the cup holder is located in the cup box.

8. The tea machine dripping and brewing tea with cold water of claim 7, wherein a refrigerating apparatus and a temperature detecting apparatus are provided in the cup box; the refrigerating apparatus and the temperature detecting apparatus are connected with the main control unit; and the main control unit detects a temperature in the cup box through the temperature detecting apparatus, and controls an opening or closing of the refrigerating apparatus according to the temperature in the cup box.

9. The tea machine dripping and brewing tea with cold water of claim 7, wherein the dripping and brewing machine further comprises a display panel; the display panel is connected with the main control unit; and the display panel is used for indicating whether the metering cup is placed on the cup holder, the water quantity in the metering cup on the cup holder and the temperature in the cup box.

10. The tea machine dripping and brewing tea with cold water of claim 7, wherein the cup box further comprises a box door; an opening and closing sensor is provided at a closing position of the cup box and the box door for sensing an opening and closing of the box door; and the opening and closing sensor is connected with the main control unit.

11. The tea machine dripping and brewing tea with cold water of claim 1, wherein the tea machine dripping and brewing tea with cold water further comprises a water pump and an outer water pipe; the water storage tank is provided with a water level gauge; the outer water pipe is connected with the water storage tank through the water pump; the water pump and the water level gauge are connected with the main control unit; the main control unit is further used for detecting a water quantity in the water storage tank through the water level gauge; and when the water quantity in the water storage tank is lower than a preset threshold, the water pump is turned on.
